(19) United States
(12) Patent Application Publication
(10) Pub. No.: US 2010/0012637 A1
(43) Pub. Date: Jan. 21, 2010

(54) ROBOTIC GMAW TORCH WITH QUICK RELEASE GOOSENECK LOCKING MECHANISM, DUAL ALIGNMENT FEATURES, AND MULTIPLE ELECTRICAL CONTACTS

(75) Inventor: Thomas Jaeger, Pointe Aux Roches (CA)

Correspondence Address: Fildes & Outland, P.C., 20916 Mack Avenue, Suite 2, Grosse Pointe Woods, MI, 48236, US

(73) Assignee: ILLINOIS TOOL WORKS INC., Glenview, IL (US)

(21) Appl. No.: 12/479,124

(22) Filed: Jun. 5, 2009

Related U.S. Application Data
(60) Provisional application No. 61/081,294, filed on Jul. 16, 2008.

(51) Int. Cl. B23K 9/29

(52) U.S. Cl. 219/136

(57) ABSTRACT

A gooseneck locking mechanism for a robotic GMAW torch having a torch body and a gooseneck includes a connector receiver disposed in the torch body. The connector receiver includes longitudinal ends and a passageway extending between the longitudinal ends. An indexing feature is disposed in the passageway. An elongated connector is mountable on a proximal end of the gooseneck. The connector includes a cooperable indexing feature. The locking mechanism further includes a detent for joining the connector receiver and the elongated connector. The indexing features align the gooseneck relative to the torch body, and the detent secures the connector in the connector receiver for quick release. The locking mechanism may include a plurality of electrical contacts in the connector receiver that are engageable with the connector to provide flow of electrical current through the connector receiver to the gooseneck.

### CROSS REFERENCE TO RELATED APPLICATION

This application claims the priority of U.S. Provisional Application No. 61/081,294 filed Jul. 16, 2008.

### TECHNICAL FIELD

This invention relates to a connection system for a robotic MIG torch assembly, and more particularly to a quick release gooseneck locking mechanism for a robotic GMAW torch.

### BACKGROUND OF THE INVENTION

Welding is used in various manufacturing and construction applications to join various metal pieces together to form a unitary piece. An arc welding system typically includes an electric power supply coupled to a welding gun that houses an electrode that is located in the handle. The electrode completes an electrical circuit with a source of power when the electrode is placed against a piece of metal to be welded. The contact between the electrode and the piece of metal produces an electric arc between the electrode and the metal piece. The heat of the electric arc is concentrated on the metal piece, or pieces, to be joined, thereby melting the metal piece (s). A filler material is added to the molten metal, which subsequently cools and solidifies, joining the metal pieces together.

Metal Inert Gas (MIG) welding is one type of arc welding. MIG welding is also referred to as “wire feed” or Gas Metal Arc Welding (GMAW). In MIG welding a metal wire is used as the electrode to produce the arc. The wire is shielded by an inert gas and the metal wire acts as the filler for the weld. The inert gas is used to shield the electric arc from contaminants and gases that may react with the weld. Typically, the wire and gas are fed through a hand-held welding gun. The wire and gas are fed to the welding gun from a welding system having a wire feeder, a power source and a source of gas.

A robotic MIG welding torch assembly typically includes a main body mountable on a robotic arm, a gooseneck, and a contact tip assembly. A cable is connected to a rearward end of the main body to supply gas, electrical current, and a consumable electrode (e.g., a metal welding wire) to the torch. The cable may be connected to a wire feeder opposite the main body. The gooseneck is operatively connected to a forward end of the main body and allows for the communication of the consumable electrode, the shielding gas, and the welding current to the contact tip assembly mounted on the gooseneck.

Conventional connectors for locating and mounting a gooseneck to the forward end of a welding torch typically include a single alignment feature for aligning the gooseneck with the welding torch. Also, conventional connectors only have a single electrical contact for providing flow of current to the gooseneck.

### SUMMARY OF THE INVENTION

The present invention provides a quick release gooseneck locking mechanism that includes dual alignment features and multiple electrical contact points, as well as a rotating ball type locking mechanism for locking a gooseneck in a desired axial position. The present locking mechanism increases the durability of the interface between the gooseneck and the torch body. The present locking mechanism also facilitates proper alignment of the gooseneck relative to the torch body when the gooseneck is replaced or exchanged for a new or different gooseneck, thereby improving the consistency of the welding torch's performance from one gooseneck to another. Further, the present locking mechanism improves the flow of electrical current from the torch body to the gooseneck by decreasing the electrical resistance at the interface between the gooseneck and the torch body.

More particularly, a gooseneck locking mechanism in accordance with the present invention for a robotic GMAW torch having a torch body and a gooseneck includes a connector receiver disposed in the torch body. The connector receiver includes longitudinal ends and a passageway extending between the longitudinal ends. An indexing feature is disposed in the passageway. An elongated connector is mountable on a proximal end of the gooseneck. The connector includes a cooperable indexing feature. The locking mechanism further includes a detent for joining the connector receiver and the elongated connector. The indexing features align the gooseneck relative to the torch body, and the detent secures the connector in the connector receiver for quick release.

The indexing features may be a cooperating key and keyway. Alternatively or in addition, the indexing features may be mating surfaces in the passageway and on the connector. The detent may be a spring-loaded ball device. The locking mechanism may further include a plurality of electrical contacts in the connector receiver. The electrical contacts are engageable with the connector to provide flow of electrical current through the connector receiver to the gooseneck.

In another embodiment, a gooseneck locking mechanism for a robotic GMAW torch having a torch body and a gooseneck includes a connector receiver disposed in the torch body. The connector receiver includes an outer wall, longitudinal ends, and a passageway extending between the longitudinal ends. An elongated key is disposed in the passageway. At least one inner mating surface is disposed in the passageway. An elongated connector is mountable on a proximal end of the gooseneck. The connector includes a keyway cooperable with the key of the connector receiver, and at least one outer mating surface cooperable with the at least one inner mating surface. The locking mechanism further includes a detent for joining the connector receiver and the elongated connector. The cooperable key and keyway and the cooperable inner and outer mating surfaces align the gooseneck relative to the torch body, and the detent secures the connector in the connector receiver for quick release.

The locking mechanism may include a plurality of electrical contacts in the connector receiver. The electrical contacts are engageable with the connector to provide flow of electrical current through the connector receiver to the gooseneck. In one embodiment, the locking mechanism may include three electrical contacts in the connector receiver. The at least one inner mating surface may be a flat surface, and the at least one outer mating surface may be a flat surface. In one embodiment, the at least one inner mating surface may be a pair of symmetrically opposed inner surfaces in the passageway, and the at least one outer mating surface may be a pair of symmetrically disposed opposite outer surfaces on the connector. The at least one outer mating surface may be disposed at an end of the connector, and one of the at least one outer mating surface may be adjacent the keyway. The key may be a generally linear protrusion in the connector housing passageway, and the keyway may be a generally linear slot in an outer surface of the connector.

The detent may include two balls seated in openings in the connector receiver outer wall, a rotating ring disposed about the connector receiver outer wall, and two depressions in an outer surface of the connector. The rotating ring has a contoured inner surface in urged engagement with the balls. Rotating the rotating ring moves the balls into and out of the openings. The balls are engageable with the holes of the connector when the balls are urged outwardly from the openings. The contoured inner surface may include a shallow recess and a deep recess. The balls are urged outwardly from the openings when engaged with the shallow recess and the balls are recessed in the openings when engaged with the deep recess. The detent may include a resilient member that urgedly engages the rotating ring with the balls. A manipulable nut may be engaged with the rotating ring, and the nut may be disposed outside of the torch body to provide for easy manipulation of the rotating ring.

A robotic GMAW torch may include a gooseneck locking mechanism as described above.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective, partial sectional view of a robotic GMAW torch including a quick release gooseneck locking mechanism in accordance with the present invention;

FIG. 1A is an enlarged view of a portion of FIG. 1;

FIG. 2 is a side, partial sectional view of the quick release gooseneck locking mechanism;

FIG. 3A is a side, partial sectional view of a locking device of the quick release gooseneck locking mechanism in an unlocked position;

FIG. 3B is a side, partial sectional view of the locking device in a locked position;

FIG. 4A is a cross-sectional view of the locking device taken along the line 4A-4A in FIG. 3A;

FIG. 4B is a cross-sectional view of the locking device taken along the line 4B-4B in FIG. 3B; and

FIG. 5 is a perspective view of the robotic GMAW torch of FIG. 1 schematically illustrating mount and dismount of a gooseneck from a torch body via the quick release gooseneck locking mechanism.

### DETAILED DESCRIPTION OF THE INVENTION

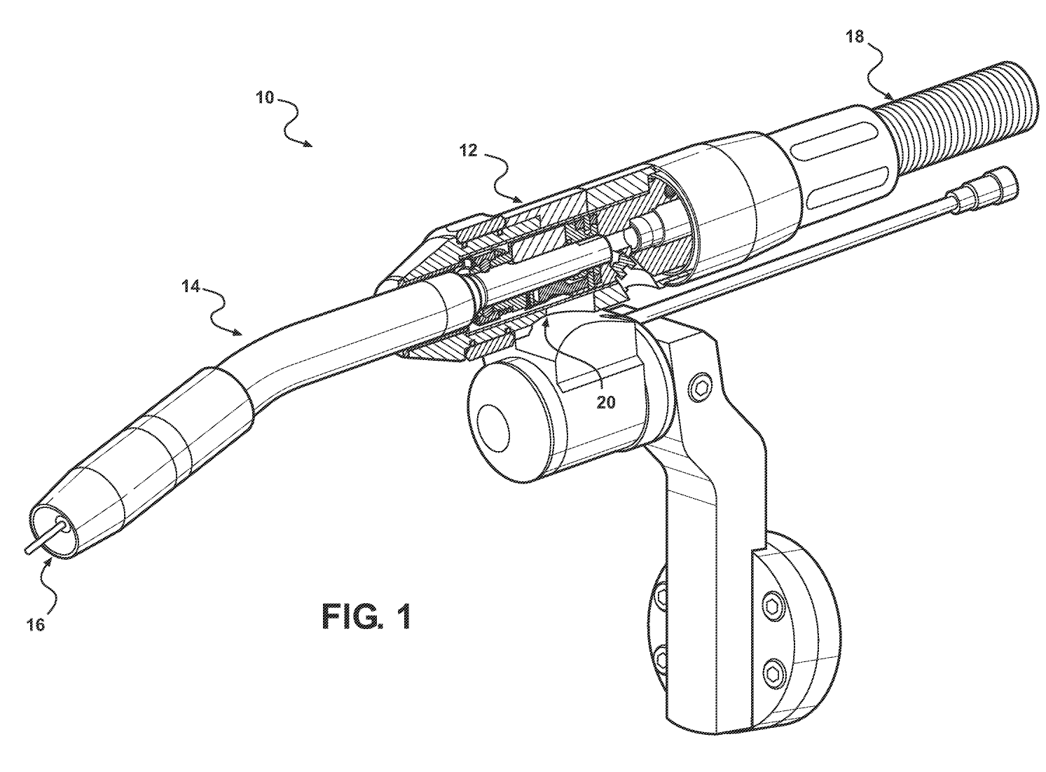

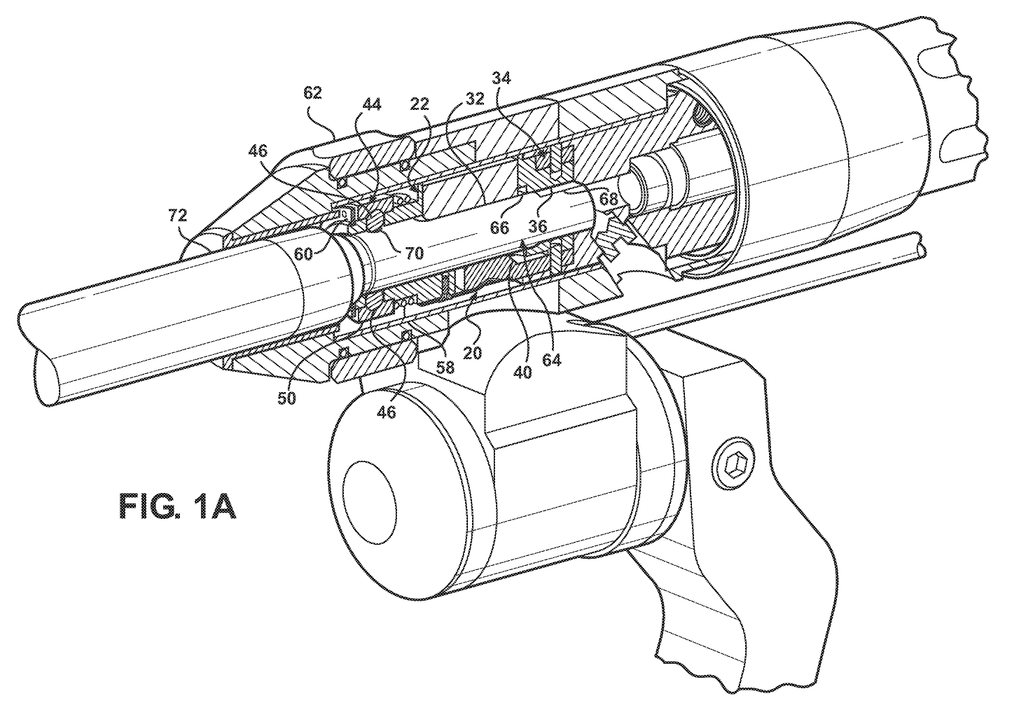

Referring now to FIG. 1 in detail, numeral 10 generally indicates a welding torch such as a gas metal arc welding (GMAW) torch or a similar welding torch. The welding torch 10 broadly includes a torch body 12, a gooseneck 14 extending from a forward end of the torch body, and a contact tip assembly 16 at a distal end of the gooseneck. A cable 18 is connected to a rear end of the torch body 12. The cable 18 supplies electrical current, shielding gas, and a consumable electrode (e.g., a metal welding wire) to the torch body 12. The electrical current, shielding gas, and consumable electrode travel through the torch body 12 to the gooseneck 14 and ultimately exit through an orifice in the contact tip assembly 16.

The welding wire, when energized for welding, carries a high electrical potential. When the welding wire makes contact with target metal workpieces, an electrical circuit is completed and current flows through the welding wire, across the metal workpieces and to ground. The current causes the welding wire and the parent metal of the workpieces in contact with the welding wire to melt, thereby joining the workpieces as the melt solidifies.

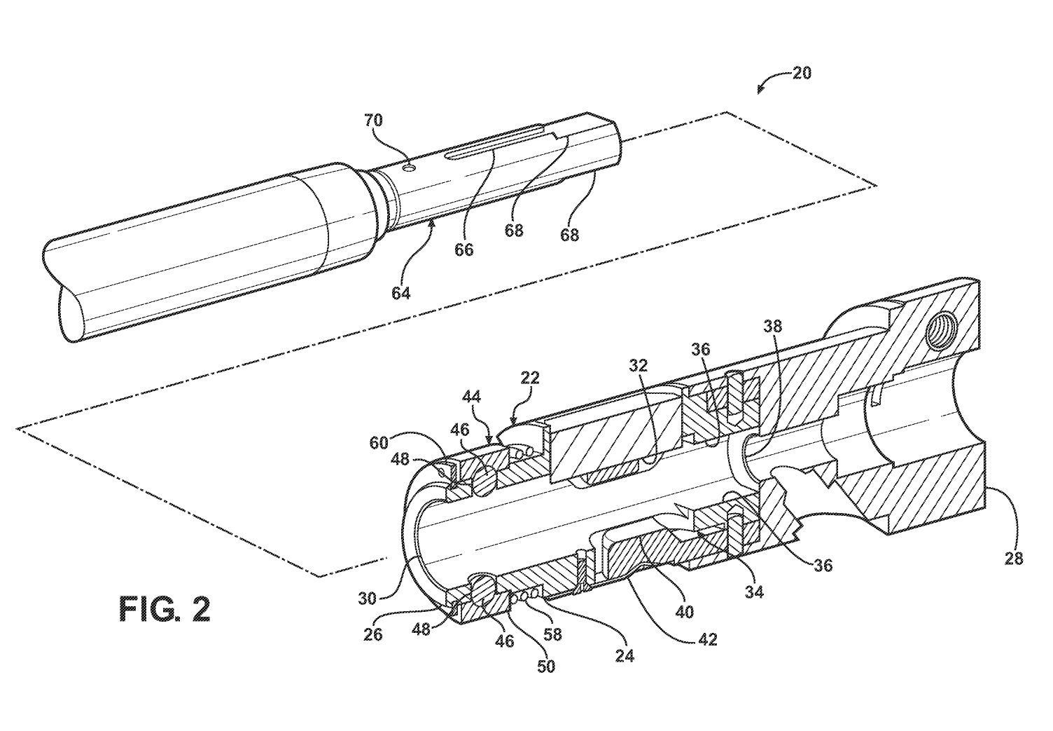

With reference to FIGS. 1-4B, the welding torch 10 includes a quick release gooseneck locking mechanism 20 in accordance with the present invention. The gooseneck locking mechanism 20 includes a connector receiver 22 disposed in the torch body 12. The connector receiver 22 is generally cylindrical in shape and has an outer wall 24 and opposite, longitudinal ends 26, 28. A passageway 30 extends through the connector receiver 22 from one longitudinal end 26 to the other end 28.

An indexing feature such as an elongated key 32 or similar is disposed in the passageway 30. The key 32 may be a generally linear protrusion in the passageway 30. The key 32 may be integral with a surface of the passageway 30 or alternatively may be a feature on a separate member that is mounted in the passageway. For example, the key 32 may be a feature on an insert that is disposed in an opening in the connector housing outer wall 24.

Another indexing feature 34 is also disposed in the passageway 30. The indexing feature 34 includes two inner mating surfaces 36. The inner mating surfaces 36 may be flat surfaces and may be symmetrically opposed to each other. However, the indexing feature 34 may have only one mating surface or more than two mating surfaces. Also, the mating surfaces may have a contour that is not flat, such as a wavy surface or a saw tooth surface. A stop 38 may be disposed adjacent the indexing feature 34.

A plurality of electrical contacts 40 are mounted in the connector receiver 22. For example, the locking mechanism 20 may include three electrical contacts 40, although fewer or more electrical contacts are within the scope of the invention. A resilient member 42 such as a flat leaf spring or similar urges each electrical contact 40 inwardly into the passageway 30 of the connector receiver 22.

A detent 44 is disposed adjacent one end 26 of the connector receiver 22. The detent 44 includes two balls such as metal balls 46 (e.g., steel spheres) or similar seated in openings 48 in the connector receiver outer wall 24. A rotating ring 50 is disposed about the connector receiver outer wall 24. The rotating ring 50 has a contoured inner surface 52 in urged engagement with the balls 46. The contoured inner surface 52 includes a shallow recess 54 and a deep recess 56. Rotation of the rotating ring 50 moves the balls 46 into and out of the openings 48. The balls 46 are urged outwardly from the openings 48 towards the passageway 30 when engaged with the shallow recess 54 and the balls 46 are recessed in the openings when engaged with the deep recess 56. A resilient member 58 such as coiled torsional spring or similar urgedly engages the rotating ring 50 with the balls 46. The resilient member 58 biases the rotating ring 50 and balls 46 into a locked position in which the balls are urged outwardly from the openings 48. Rotating the rotating ring 50 against the force of the resilient member 58 turns the deep recess 56 into alignment with the balls 46, i.e. an unlocked position in which the balls are free to fully retract into the openings 48. A retaining ring 60 such as an external snap ring or similar disposed opposite from the resilient member 58 holds the rotating ring 50 on the connector receiver 22. A hand manipulable nut 62 disposed on the outside of the torch body 12 may be engaged with the rotating ring 50. The nut 62 provides for easy manipulation of the rotating ring by an operator's hand from outside the torch body 12. The nut 62 also allows for electrical isolation of the rotating ring 50.

The locking mechanism 20 also includes an elongated, generally cylindrical connector 64 that is mountable on a proximal end of the gooseneck 14. The connector 64 includes an indexing feature such as a keyway 66 or similar that is cooperable with the key 32 of the connector receiver 22. The keyway 66 may be a generally linear slot in an outer surface of the connector 64. The connector 64 also includes two outer mating surfaces 68 cooperable with the inner mating surfaces 36 of the connector receiver 22. The number of outer mating surfaces 68 should match the number of inner mating surfaces 36, because the outer mating surfaces mate with the inner mating surfaces when the connector 64 is inserted into the connector receiver 22 as described in more detail below. Also, for the same reason, the contour of the outer mating surfaces 68 should mirror the contour of the inner mating surfaces 36. The outer mating surfaces 68 are disposed at an outer end of the connector 64. One of the outer mating surfaces 68 is also adjacent the keyway 66. The connector 64 further includes a pair of depressions 70 that are features of the detent 44. The balls 46 of the detent 44 are engageable with the depressions 70 to join the connector receiver 22 and the connector 64 as described in more detail below.

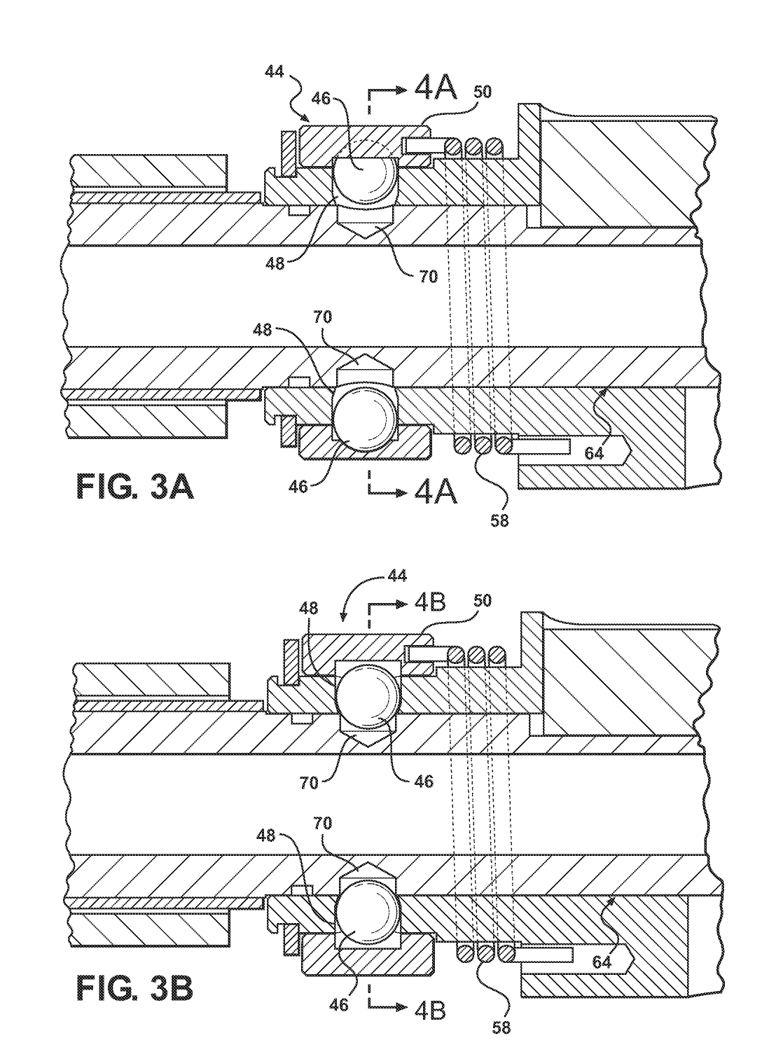

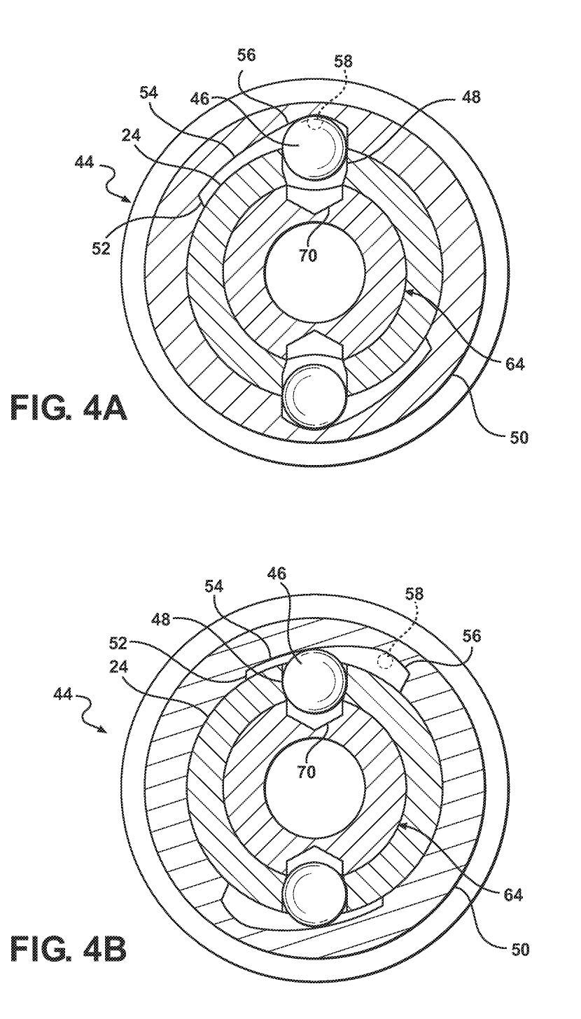

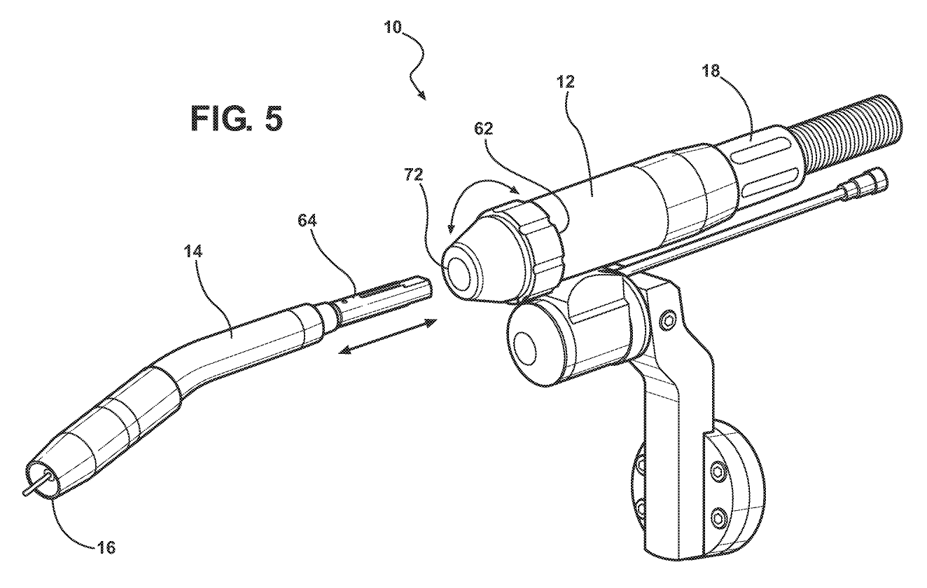

Turning to FIG. 5, to mount a gooseneck 14 on the torch body 12, an operator uses a free hand to turn the nut 62 on the outside of the torch body. Rotation of the nut 62 turns the rotating ring 50 inside of the torch body 12 into the unlocked position as shown in FIGS. 3A and 4A. The connector 64 mounted on the end of the gooseneck 14 is then inserted into the passageway 30 of the connector receiver 22 through an opening 72 in the torch body 12. The operator rotates the gooseneck 14 axially so that the key 32 in the connector receiver 22 is aligned with the keyway 66 in the connector 64. When properly aligned, the key 32 slides into the keyway 66 as the connector 64 is inserted into the passageway 30. When the outer end of the connector 64 reaches the indexing feature 34, the inner mating surfaces 36 in the passageway 30 mate with the outer mating surfaces 68 on the connector. The mating of the inner and outer surfaces 36, 68 in addition to the mating of the key 32 in the keyway 66 provide for and maintain proper alignment of the connector 64 in the connector receiver 22, which in turn properly indexes the gooseneck 14 relative to the torch body 12. When the connector 64 is fully inserted into the connector receiver 22, the nut 62 may be released. The resilient member 58 returns the rotating ring 50 back to a home, locked position as shown in FIGS. 3B and 4B. In the locked position, the shallow recesses 54 of the rotating ring 50 engage the balls 46 and urge the balls outwardly relative to the openings 48 and into engagement with the depressions 70 on the connector 64. The engagement of the balls 46 with the depressions 70 locks the connector 64 in the connector receiver 22.

Additionally, when the connector 64 is inserted into the connector receiver 22, the resilient members 42 urge the electrical contacts 40 into engagement with the connector to provide flow of electrical current from the connector receiver through the connector to the gooseneck 14.

To exchange or replace the gooseneck 14 with another gooseneck, an operator may turn the nut 62 to rotate the rotating ring 50 into the unlocked position and then pull the gooseneck 14 and connector 64 out of the torch body 12 and connector receiver 22. As the connector 64 is pulled out of the connector receiver 22, the outer surface of the connector pushes the balls 46 into the deep recesses 56 of the rotating ring 50, thereby allowing the connector to freely move in the passageway 30 of the connector receiver 22. Once the gooseneck 14 is removed from the torch body 12, the operator may insert a different gooseneck into the torch body in the same manner as described above.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A gooseneck locking mechanism for a robotic GMAW torch having a torch body and a gooseneck, said locking mechanism comprising:
a connector receiver disposed in said torch body, said connector receiver including longitudinal ends and a passageway extending between said longitudinal ends;
an indexing feature disposed in said passageway;
an elongated connector mountable on a proximal end of said gooseneck;
said connector including a cooperable indexing feature;
a detent for joining said connector receiver and said elongated connector;
wherein said indexing features align said gooseneck relative to said torch body, and said detent secures said connector in said connector receiver for quick release.

2. The gooseneck locking mechanism of claim 1, wherein said indexing features are a cooperating key and keyway.

3. The gooseneck locking mechanism of claim 1, wherein said indexing features are mating surfaces in said passageway and on said connector.

4. The gooseneck locking mechanism of claim 1, wherein said detent is a spring-loaded ball device.

5. The gooseneck locking mechanism of claim 1, including a plurality of electrical contacts in said connector receiver, said electrical contacts being engageable with said connector to provide flow of electrical current through said connector receiver to said gooseneck.

6. A gooseneck locking mechanism for a robotic GMAW torch having a torch body and a gooseneck, said locking mechanism comprising:
a connector receiver disposed in said torch body, said connector receiver including an outer wall, longitudinal ends, and a passageway extending between said longitudinal ends;
an elongated key disposed in said passageway;
at least one inner mating surface disposed in said passageway;
an elongated connector mountable on a proximal end of said gooseneck;
said connector including a keyway cooperable with said key of said connector receiver, and at least one outer mating surface cooperable with said at least one inner mating surface;
a detent for joining said connector receiver and said elongated connector;
wherein said cooperable key and keyway and said cooperable inner and outer mating surfaces align said gooseneck relative to said torch body, and said detent secures said connector in said connector receiver for quick release.

7. The gooseneck locking mechanism of claim 6, including a plurality of electrical contacts in said connector receiver, said electrical contacts being engageable with said connector to provide flow of electrical current through said connector receiver to said gooseneck.

8. The gooseneck locking mechanism of claim 7, including three electrical contacts in said connector receiver.

9. The gooseneck locking mechanism of claim 6, wherein said at least one inner mating surface is a flat surface, and said at least one outer mating surface is a flat surface.

10. The gooseneck locking mechanism of claim 6, wherein said at least one inner mating surface is a pair of symmetrically opposed inner surfaces in said passageway, and said at least one outer mating surface is a pair of symmetrically disposed opposite outer surfaces on said connector.

11. The gooseneck locking mechanism of claim 6, wherein said at least one outer mating surface is disposed at an end of said connector.

12. The gooseneck locking mechanism of claim 6, wherein one of said at least one outer mating surface of said connector is adjacent said keyway.

13. The gooseneck locking mechanism of claim 6, wherein said key is a generally linear protrusion in said connector housing passageway, and said keyway is a generally linear slot in an outer surface of said connector.

14. The gooseneck locking mechanism of claim 6, wherein said detent includes:
two balls seated in openings in said connector receiver outer wall;
a rotating ring disposed about said connector receiver outer wall, said rotating ring having a contoured inner surface in urged engagement with said balls; and
two depressions in an outer surface of said connector;
whereby rotating said rotating ring moves said balls into and out of said openings, and said balls are engageable with said depressions of said connector when said balls are urged outwardly from said openings.

15. The gooseneck locking mechanism of claim 14, wherein said contoured inner surface includes a shallow recess and a deep recess, whereby said balls are urged outwardly from said openings when engaged with said shallow recess and said balls are recessed in said openings when engaged with said deep recess.

16. The gooseneck locking mechanism of claim 14, wherein said detent includes a resilient member that urgedly engages said rotating ring with said balls.

17. The gooseneck locking mechanism of claim 14, including a manipulable nut engaged with said rotating ring, said nut being disposed outside of said torch body and providing for easy manipulation of said rotating ring.

18. A robotic GMAW torch including the gooseneck locking mechanism of claim 1.
